(19) United States
(12) Patent Application Publication
(10) Pub. No.: US 2026/0339723 A1
(43) Pub. Date: Oct. 29, 2026

(54) DATA INTERCEPT BASED MULTI-TENANT ORCHESTRATION ENGINE FOR SINGLE-TENANT APPLICATIONS

(71) Applicant: ADP, INC, Roseland, NJ (US)

(72) Inventors: Vijayanand Veeraraghavan, Chennai (IN); Badrinarayanan Lakshmiraghavan, Chennai (IN); Saravana Kumar, Chennai (IN); Haribabu Mohan, Chennai (IN)

(73) Assignee: ADP, INC, Roseland, NJ (US)

(21) Appl. No.: 19/192,443

(22) Filed: Apr. 29, 2025

(51) Int. Cl. G06F 9/50

(52) U.S. Cl. CPC G06F 9/5027

(57) ABSTRACT

A multi-tenant orchestration engine for a single-tenant application may be provided. One or more rows in a table of an application database for the single-tenant application may be identified that include modified data in a date field of the table. A modified rows message may be sent to a modified rows message queue, which includes a corresponding row identifier for each row. The modified rows message may be received and, for each of the one or more rows, a corresponding set of modified fields having a corresponding set of modified values identified. The corresponding row identifier and the corresponding set of modified values may be stored as metadata in an orchestration engine database. Job schedule instances may be updated and/or created in the orchestration engine database based on the corresponding set of modified values in each row. A subset of the job schedule instances may be identified to execute.

### TECHNICAL FIELD

This application relates to single-tenant applications and, in particular, to supporting multiple instances of single-tenant applications.

### BACKGROUND

Present single-tenant applications suffer from a variety of drawbacks, limitations, and disadvantages. Accordingly, there is a need for inventive systems, methods, components, and apparatuses described herein.

### BRIEF DESCRIPTION OF THE DRAWINGS

The examples may be better understood with reference to the following drawings and description. The components in the figures are not necessarily to scale. Moreover, in the figures, like-referenced numerals designate corresponding parts throughout the different views.

FIG. 1 illustrates a first example of a multi-tenant orchestration engine for a single-tenant application;

FIG. 2 is an entity diagram showing examples of entities related to the orchestration engine that may be stored in the application database;

FIG. 3 is an entity diagram of example entities in the orchestration engine database;

FIGS. 4A-4C illustrate an example of the orchestration engine implemented in Amazon's cloud technologies;

FIG. 5 illustrates an example flow diagram of the logic of the orchestration engine;

FIG. 6 shows example components of the orchestration engine in a memory; and

FIG. 7 illustrates an example of a table and a change log in the application database.

### DETAILED DESCRIPTION

A single-tenant application refers to a hosted application where each client (in other words, customer) has its own instance of the application. Potential advantages of the single-tenant application may include, for example, improved data security through data segregation and improved flexibility in customizing the application. In contrast, a multi-tenant application refers to a hosted application where multiple clients share a common instance of the application even if each client has its own data.

In one example, a multi-tenant orchestration engine for a single-tenant application is provided. The example multi-tenant orchestration engine includes a modified rows module, a metadata document builder, a schedule builder and a jobs module. The modified rows module is configured to identify one or more rows in a table of an application database that include modified data in a date field of the table, where the application database is for the single-tenant application. The modified rows module is further configured to send a modified rows message to a modified rows message queue, the modified rows message including a corresponding row identifier for each of the one or more rows. The metadata document builder is configured to receive the modified rows message from the modified rows message queue and to identify, for each of the one or more rows, a corresponding set of modified fields in the table having a corresponding set of modified values, where the metadata document builder is further configured to store, for each of the one or more rows, the corresponding row identifier and the corresponding set of modified values as metadata in an orchestration engine database. The schedule builder is configured to update and/or create one or more job schedule instances in the orchestration engine database based on the corresponding set of modified values in each of the one or more rows. The jobs module is configured to identify a subset of the job schedule instances to execute by querying the job schedule instances and/or the metadata in the orchestration engine database at a regular interval, wherein the jobs module is further configured to initiate execution of the subset of the job schedule instances.

One technical advantage of the systems and methods described below may be that it may be less error prone and more stable for applications where there are a substantial number of date fields on which the application sends out notifications, provides reminders, and/or on which schedules of jobs are based. Alternatively, or in addition, a technical advantage may be that it avoids being heavily bloated with redundant messages for every single date for every single occurrence of the same date value in the system across multiple instances of the application. Alternatively, or in addition, a technical advantage may be that the multi-tenant orchestration engine may provide performance advantages over alternative approaches involving a multi-tenant solution by avoiding unnecessary querying of all of the instances of application databases on a regular interval in order to identify a subset of the job schedule instances to execute.

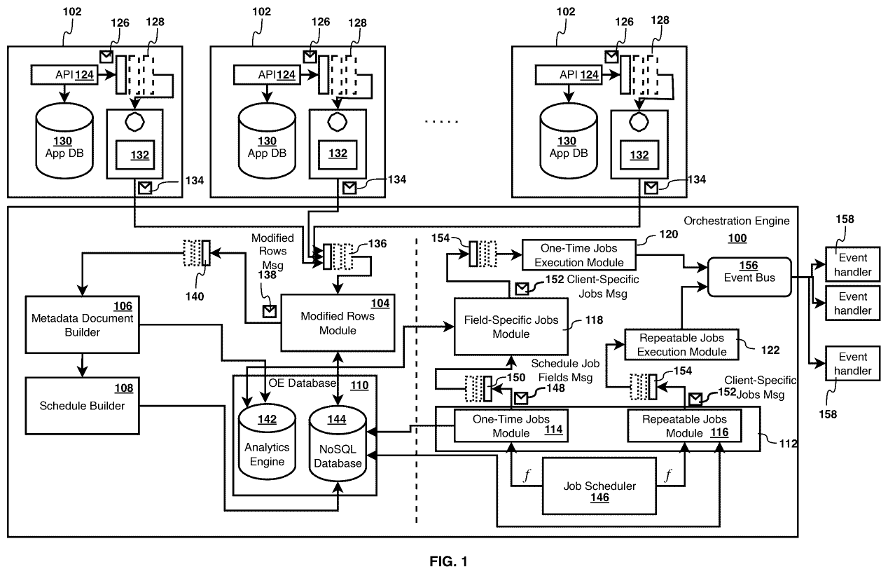

FIG. 1 illustrates a first example of a multi-tenant orchestration engine 100 for a single-tenant application 102. The orchestration engine 100 in the illustrated example includes, for creating and/or updating any scheduled jobs, a modified rows module 104, a metadata document builder 106, a schedule builder 108, and an orchestration engine database 110. The example of the orchestration engine 100 in FIG. 1 also includes, for identifying and initiating job execution, a jobs module 112, a field-specific jobs module 118, a one-time jobs execution module 120, and a repeatable jobs execution module 122.

There may be multiple instances of the single-tenant application 102. Each instance of the single-tenant application 102 includes its own application database 130. The single-tenant application 102 may persist its data in the application database 130.

The orchestration engine database 110 may include one or more databases. In the illustrated example, the orchestration engine database 110 includes an analytics engine 142 and a NoSQL database 144.

During operation of the multi-tenant orchestration engine 100, the orchestration engine 100 may learn of modifications to the data in the instances of the application database 130 through a data intercept mechanism. In the illustrated example, writes to the application database 130 are made via a data API 124. In response to a write to the application database 130, an implementation of the data API 124 may send a data write message 126 to a data write message queue 128, where the data write message 126 includes information about the write. For example, the data write message 126 may (1) include the modified data (changed, newly inserted, or deleted) written to the application database 130 and (2) identify one or more tables and one or more fields of the tables being modified.

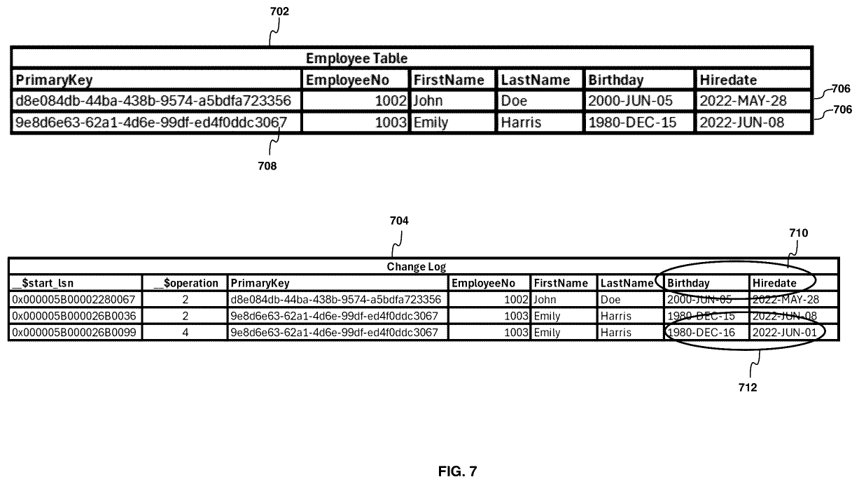

The single-tenant application 102 may include a field filter module 132 that is a subscriber to the data write message queue 128. As a subscriber, the field filter module 132 may receive the data write messages 126 from the data write message queue 128. The field filter module 132 may pass the information received in the data write messages 126 to the multi-tenant orchestration engine 100 by sending one or more written fields messages 134 to a written fields message queue 136 for the multi-tenant orchestration engine 100 to process. The written fields messages 134 may identify the fields containing the modified data and the tables containing the fields. See, for example, FIG. 7. The written fields messages 134 may also include a client identifier that identifies an instance of the single-tenant application 102.

The field filter module 132 may filter the information received in the data write messages 126 down to a subset of the information before passing the subset of the information on to the orchestration engine 100. In a first example of filtering, the field filter module 132 may not include the modified data itself but instead include an identity of the field and table containing the modified data. In a second example of filtering, the field filter module 132 may processes multiple data write messages 126 and send a smaller number of written fields messages 134 that identify the field or fields that included modified data in the data write messages 126 that were processed by the field filter module 132. This is an example of data deduplication.

As a third example of filtering, if the data write message 126 indicates a field in a row of a table in the application database 130 has been modified, then the field filter module 132 may first determine whether the field is included in a set of search fields 202 for the table. The set of search fields 202 identifies one or more fields in the table which affects scheduling of a job or which may otherwise be of interest to the orchestration engine 100. For example, the set of search fields may be specified in a search fields table in the application database 130 and/or be a fixed set of fields. Next, the field filter module 132 identifies the field in the written fields message 134 for the orchestration engine 100 only if the field is included in the set of search fields.

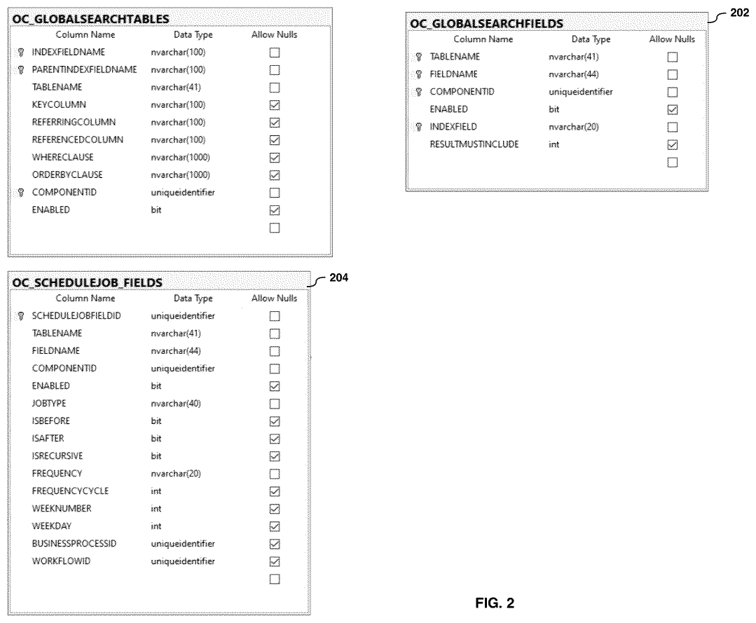

FIG. 2 is an entity diagram showing examples of entities related to the orchestration engine 100 that may be stored in the application database 130. In the illustrated example, a set of search fields 202 for a corresponding table are stored in a OC_GLOBALSEARCHFIELDS table, and the corresponding set of tables of interest containing the set of search fields 202 are stored in OC_GLOBALSEARCHTABLES. This enables the set of search fields 202 to be customized.

Referring again to FIG. 1, the modified rows module 104 of the orchestration engine 100 is configured to identify one or more rows in a table of the application database 130 that includes modified data in a field belonging to the set of search fields 202. For example, the modified rows module 104 may receive the written fields message 134 from the written fields message queue 136 and identify the one or more rows that include the modified data in the field based on the field, the table containing the field, and the client identifier included in the written fields message 134.

Alternatively, or in addition, the modified rows module 104 may identify the one or more rows that include the modified data in the field of the table based on a change log in the application database 130. The change log may be a database feature to track changes to tables in the application database 130. The change log may be any database solution that tracks changes to data in tables in the application database 130. For example, the Change Data Capture (CDC) feature of a SQL Server database records activity on a SQL Server database when tables and rows have been modified. See, for example, FIG. 7. Another example of the change log includes the Oracle CDC feature of an Oracle database. With CDC, source tables may be identified as tracked tables by calling a stored procedure with suitable parameters. When tracking of a table is enabled for CDC, an associated capture instance is created to access the change data for the source table. The capture instance includes a change table that identifies the modified data of the source table. Each row in the change table also includes other metadata to allow interpretation of the change activity. For example, the change table may have a column that contains a commit log sequence number (LSN) that is assigned to a change represented by a row in the change table.

Returning to the discussion of the modified rows module 104, the modified rows module 104 may identify the one or more rows that include the modified data in the field of the table based on the change log in the application database 130. To that end, the modified rows module 104 may look up a last fetched LSN for the specific combination of the field, table, and client identifier in the orchestration engine database 110. For example, the last fetched LSNs may be stored as key value pairs in the NoSQL database 144, where the key comprises a combination of field, table, and client identifier, and the value is a corresponding last fetched LSN. Next, the modified rows module 104 may query the change log-for example, the CDC change table in the application database 130 for all changes that occurred after the last fetched LSN to field identified in the written fields message 134. As a result of this query, the modified rows module 104 may receive row identifiers for the one or more rows that include the modified data in the field and a new last fetched LSN for the specific combination of the field, table, and client identifier. The modified rows module 104 may update the last fetched LSN for the specific combination of the field, table, and client identifier in the orchestration engine database 110 for future use.

The modified rows module 104 may send a modified rows message 138 to a modified rows message queue 140. The modified rows message 138 may include a corresponding row identifier for each of the one or more rows that include the modified data in the field. The row identifier may be, for example, a primary key value.

In some examples, as a result of querying the change log, the modified rows module 104 may also learn which fields have been modified for each of the one or more rows that include the modified data in the field. In such examples, the modified rows module 104 may include, in the modified rows message 138, the corresponding identity of the fields in which data has been modified for each of the one or more rows. In some examples, the modified rows module 104 may identify, in the modified rows message 138, only the fields in which data has been modified for each of the one or more rows that are also in the set of search fields 202. The fields in which data has been modified may vary from row to row.

The metadata document builder 106 may receive the modified rows message 138 from the modified rows message queue 140. The metadata document builder 106 may identify, for each of the one or more rows identified in the modified rows message 138, a corresponding set of modified fields in the table having a corresponding set of modified values. In some examples, the modified rows message 138 identifies the set of modified fields. In other examples, the metadata document builder 106 may identify the set of modified fields from the change log. The metadata document builder 106 may obtain the set of modified values for the set of modified fields from the change log. In some examples, the metadata document builder 106 may limit the set of modified values to modifications made on or before the new last fetched LSN for the specific combination of the field, table, and client identifier stored in the orchestration engine database 110.

The metadata document builder 106 may determine the set of search fields 202 for the table, and to limit, for each of the one or more rows, the corresponding set of modified fields in the table to the set of search fields 202 for the table. Alternatively, the metadata document builder 106 may rely on the modified rows module 104 to have already identified, in the modified rows message 138, only the fields in which data has been modified for each of the one or more rows that are also in the set of search fields 202.

The metadata document builder 106 may store, for each of the one or more rows, the corresponding row identifier and the corresponding set of modified values as metadata in the orchestration engine database 110. For example, the metadata document builder 106 may store the metadata in the analytics engine 142. The metadata document builder 106 may store the metadata as, for example, a JSON document. As a result, the orchestration engine database 110 may contain substantially up-to-date values for the set of search fields 202 for the multiple instances of the single-tenant application 102. If the analytics engine 142 requires any index update, the metadata document builder 106 may initiate the index update. For example, if the analytics engine 142 is Elasticsearch, then an Elasticsearch index is a logical namespace that holds a collection of documents, where each document is a JSON document comprising fields. If the newly generated JSON document of metadata changes the logical namespace, then the metadata document builder 106 may update the index accordingly.

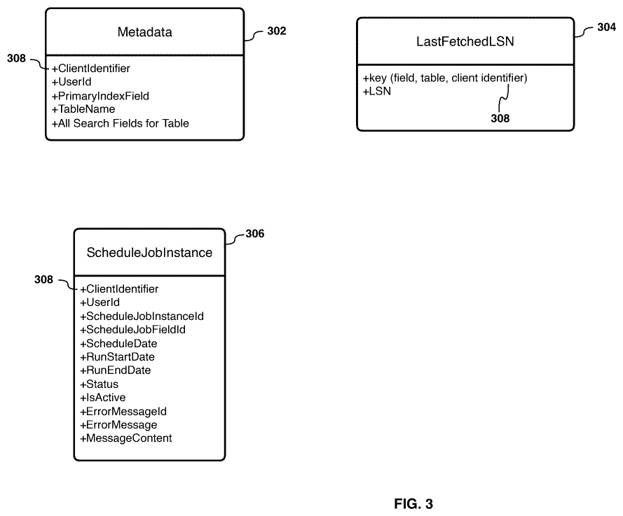

FIG. 3 is an entity diagram of example entities in the orchestration engine database 110. As explained above, the entities may include, for example, metadata 302 updated by the metadata document builder 106 and last fetched LSNs 304 updated by the modified rows module 104. The entities in the orchestration engine database 110 also include job schedule instances 306, which are explained further below. Including a client identifier 308 in the entities enables the orchestration engine 100 to determine which instances of the single-tenant application 102 the entities belong.

As shown in FIG. 2, a job schedule field 204 may be stored in the application database 130 as, for example, an OC_SCHEDULEJOBS_FIELDS table. An entry in the job schedule field 204 represents a job type that may be scheduled. In addition, the entry in job schedule field 204 identifies a field in a table which affects the schedule of the job type. For example, one job type may be to send an email to employees on the employees' birthdays. The employee table in the application database 130 may have a field called birthdate in which the employees' birthdates are stored. See, for example, FIG. 7. Accordingly, there may be an entry in the OC_SCHEDULEJOBS_FIELDS table for the job schedule field 204 for the birthday email job type. In the entry for the job schedule field 204, the field name may be “birthday,” the table name may be “employee,” the job type may be “birthday email,” and the frequency may be “annually.” There may be multiple entries in the OC_SCHEDULEJOBS_FIELDS table for any one field in a table if there are multiple types of jobs that are scheduled based on that field.

As shown in FIG. 3, job schedule instances 306 may be stored in the orchestration engine database 110. The job schedule instance 306 may represent a scheduled job. Alternatively, or in addition, the job schedule instance 306 may represent a determined entry in the application database 130 (and correspondingly, in the metadata 302), where a scheduled job is based on and/or is to process the determined entry. The job schedule instance 306 may have a ScheduleJobFieldID that identifies the job schedule field 204 and, via the job schedule field 204, the job type of the scheduled job and the field on which the schedule of the scheduled job is based. The scheduled job may be executed one or more times as dictated by the schedule indicated in the job schedule field 204.

The rule for creating the job schedule instance 306 may vary. As noted above, in some examples, the job schedule instance 306 represents a determined entry in the application database 130, where a scheduled job is based on and/or is to process the determined entry. Consider an example involving two date fields of an employee table in the application database 130, namely birthdate and hire date. Consider two example job types, a birthday reminder and an anniversary reminder, that each have a respective entry in in the job schedule field 204 identifying the birthdate and hire date fields respectively.

As an example, one client has 100 employees whose birthday falls on April 7 and 50 employees whose birthday falls on April 8. Consequently, there may be 150 corresponding job schedule instances 306 for the birthday reminder job type, one for each employee having a run start date matching their respective birthdate. Similarly, if the client has 100 employees whose anniversary falls on May 7 and 50 employees whose anniversary falls on May 8, 150 there may be 150 corresponding job schedule instances 306 for the anniversary reminder job type. On 4 different dates, reminders may be sent: 100 Birthday reminders on April 7; 50 Birthday reminders on April 8; 100 Anniversary reminders on May 7; and 50 Anniversary reminders on May 8. In summary, there will be 300 job schedule instances 306 to process for the client for these two job types. Each of the job schedule instances 306 may identify the respective one of the determined entries in the application database 130. For example, a primary key of the determined entry may be included in the MessageContent field of the job schedule instance 306. The determined entries in this example are the employees.

Alternatively, or in addition, one or more job types in the job schedule field 204 may not have any corresponding job schedule instances 306 created. For example, some job types that have to run on a predetermined date may not have any corresponding job schedule instances 306 created. Examples of such job types may include jobs based on date fields like Birthday, Anniversary, Passport Expiry Date, Visa Expiry, and any national document expiry Date. For such job types, a process that runs at a regular interval may search the metadata 302 in the orchestration engine database 110 for any entries having a value in such date fields matching the current date and then initiate one or more jobs to process the matching entries.

Alternatively, or in addition, for some job types, the job schedule instance 306 may represent a scheduled job for one or more determined entries in the application database 130. For example, the scheduled job may be executed on a date calculated from the value of a field for the determined entries, where the field is identified in the job schedule field 204 for the job type. For example, some job types are configured to run plus n days (or minus n days) from the date in the field identified in the job schedule field 204 for the job type. The job schedule instance 306 may be created having a schedule date set to the calculated date. Consider an example where a job type called “passport reminder” is configured in an entry in the job schedule field 204 for a notification or a reminder to be sent 5 days before a passport expiry date, where the field name is “passport expiry date” in the “employee” table. If one or more employees has a passport expiry date of May 31, 2025, then the job schedule instance 306 having ScheduleDate of May 26, 2025 is created, where May 26, 2025 is 5 days before May 31, 2025. This means there is a “passport reminder” job that needs to run on May 26, 2025. In this example, only one entry in the job schedule instance 306 is created for the “passport reminder” job per client per scheduled day even if more than one employee is to receive the passport reminder on the scheduled day.

Alternatively, or in addition, for some job types, the job schedule instance 306 may represent a determined entry in the application database 130, where a job is to execute on a date calculated from the value of the field for the determined entry, where the field is identified in the job schedule field 204 for the job type. For example, some job types are configured to run plus n days (or minus n days) from the date in the field identified in the job schedule field 204 for the job type. The job schedule instance 306 may be created having a schedule date set to the calculated date, and the job schedule instance 306 may identify the determined entry in the application database 130.

As explained above, the metadata document builder 106 has identified, for each of the one or more rows identified in the modified rows message 138, a corresponding set of modified fields in the table having a corresponding set of modified values. Based on the set of modified fields in the table and the corresponding set of modified values, the schedule builder 108 may update and/or create one or more job schedule instances 306 in the orchestration engine database 110. For each modified field in the set of modified fields, the schedule builder 108 may identify all of the matching job schedule fields 204. The schedule builder 108 may update and/or create one or more job schedule instances 306 in the orchestration engine database 110 corresponding to the job schedule fields 204 identified from the set of modified fields. The appropriate rule for creating the job schedule instances 306 may be followed when update and/or create one or more job schedule instances 306 in the orchestration engine database 110.

Consider an example where the birthdate of an employee is changed. The schedule builder 108 may, for example, search the metadata 302 in the orchestration engine database 110 for the job schedule instances 306 associated with the employee and the client that are for job types in the job schedule field 204 having a field that is the birthday field. The schedule builder 108 may update the job schedule instances 306 in the orchestration engine database 110 having a schedule based on the birthdate value that may be affected by the change in birthdate of this employee. Similarly, the schedule builder 108 may insert the job schedule instance 306 in the orchestration engine database 110 having a schedule based on the new birthdate value if the job schedule instance 306 having the schedule based on the new birthdate value does not already exist.

During operation of the orchestration engine 100, the orchestration engine 100 also may identify and initiate job execution. In particular, the jobs module 112 may identify a subset of the job schedule instances 306 to execute by, for example, querying the job schedule instances 306 and/or the metadata 302 in the orchestration engine database 110 at a regular interval, such as hourly or daily. The jobs module 112 may initiate execution of the subset of the job schedule instances 306.

Execution of the jobs module 112 may be initiated by a job scheduler 146, such as chron on UNIX, Windows Task Scheduler on Windows, or Amazon's EventBridge Scheduler in AWS. The job scheduler 146 may be any software component that controls the execution of software task at specific times or in response to events. Here, the job scheduler 146 may initiate execution of the jobs module 112 at the regular interval.

In the illustrated example, the jobs module 112 includes a one-time jobs module 114 and a repeatable jobs module 116. The one-time jobs module 114 identifies a subset of the job schedule instances 306 in the orchestration engine database 110 to execute that are scheduled to run only once and only on the current date (in other words, the date on which the one-time jobs module 114 is identifying the subset of the job schedule instances). The one-time job module 114 identifies the subset of the job schedule instances 306 by querying the job schedule instances 306 in the orchestration engine database 110 at the regular interval in order to find the job schedule instances 306 having a one-time frequency and a run start date matching the current date. The one-time frequency may be indicated by, for example, a value of null or one in the frequency field of the job schedule instances 306. As explained further below in more detail, the repeatable jobs module 116 identifies a subset of the job schedule instances 306 in the orchestration engine database 110 to execute on the current date that the one-time jobs module 114 did not identify and process.

The jobs module 112, specifically the one-time jobs module 114 in the illustrated example, may find the job schedule fields 204 and corresponding client identifier 308 for the subset of the job schedule instances 306 identified by the one-time jobs module 114. The one-time jobs module 114 may accomplish this by, for example, selecting the job schedule fields 204 and corresponding client identifier 308 when fetching the subset of the job schedule instances 306 in the orchestration engine database 110 that correspond to the subset of the job schedule instances 306 found in the orchestration engine database 110. The subset of the job schedule instances 306 reference the corresponding job schedule fields 204 via, for example, the SCHEDULEJOBFIELDID field.

Once in possession of the job schedule fields 204, the one-time jobs module 114 may identify the set of unique field names in the job schedule fields 204, by which is meant, a set of unique field names when their respective table names are taken into consideration. For example, a hire date in table A is considered a different field name than a hire date in table B even though “hire date” is the name of the field in both tables. The one-time jobs module 114 may send a schedule job fields message 148 for each of field names to a schedule job fields message queue 150. The schedule job fields message 148 may identify the field name and one or more client identifiers 308 for the respective field name. There may be multiple client identifiers 308 because the field name may have affected job schedules in multiple instances of the single-tenant application 102. The client identifiers 308 identify the affected instances of the single-tenant application 102. The client identifier 308 may be included in the job schedule instance 306. In some examples, the schedule job fields message 148 may identify the subset of the job schedule instances 306 found in the orchestration engine database 110 that are scheduled based on the field name included in the schedule job fields message 148.

The field-specific jobs module 118 may receive the schedule job fields message 148 from the schedule job fields message queue 150. The field-specific jobs module 118 handles splitting the job schedule instances 306 by client. For example, the field-specific jobs module 118 may identify the job schedule instances 306 for each client (in other words, for each of the affected instances of the single-tenant application 102) having a schedule based on the field name identified in the schedule job fields message 148. For example, the field-specific jobs module 118 may, for each of the clients, query the job schedule fields 204 in the corresponding application database 130, where the field name matches the field name identified in the schedule job fields message 148.

In some examples, the field-specific jobs module 118 may further create the job schedule instances 306 in the orchestration engine database 110 for those clients and entities having a value in the corresponding application database 130 in the field name matching the current date. The field-specific jobs module 118 may accomplish this by, for example, searching the metadata 302 in the orchestration engine database 110 to see if any entry has a value in the field name matching the current date for the client, where the field name is identified in the schedule job fields message 148. If there is no value in the field name matching the current date for the client, there may be no need to execute any jobs scheduled based on the field name. For example, if the field name is birthdate of the employee table, and no employee for the client has a birthdate matching the current date, there may be no need to execute the birthday email job for the client on the current date. In alternative examples, if there are one or more entries in the metadata 302 for a client, then the field-specific jobs module 118 may not create the job schedule instances 306 corresponding to the entries. In such examples, for some job types, the job schedule instance 306 may represent a scheduled job for one or more determined entries in the application database 130. Instead of creating the job schedule instances 306 for those clients and entities having a value in the corresponding application database 130 in the field name matching the current date, identifiers, such as a primary key, of the matching entities may be used by the field-specific jobs module 118 as described further below.

The field-specific jobs module 118 may then send a client-specific jobs message 152 to a client-specific jobs message queue 154, where the client-specific jobs message 152 identifies the type of job or jobs that the job schedule instances 306 indicate are scheduled to execute for the client. The type of job or jobs may be indicated, for example, by the job schedule fields 204 corresponding to the job schedule instances 306 identified by the field-specific jobs module 118 for the client. Alternatively, or in addition, the client-specific jobs message 152 may identify the job schedule instances 306 identified by the field-specific jobs module 118 for the client. Alternatively, or in addition, the client-specific jobs message 152 may identify the matching entities identified by the field-specific jobs module 118 for the client.

The one-time jobs execution module 120 may read the client-specific jobs message 152 from client-specific jobs message queue 154. The one-time jobs execution module 120 may initiate execution of each of the job types identified in the client-specific jobs message 152. For example, the one-time jobs execution module 120 may send an event over an event bus 156 for each of the job types. An event handler 158 may execute the type of job identified by the corresponding event that the event handler 158 receives. The event handler 158 may access information stored in the orchestration engine 100 and/or the application database 130 in the process of executing, or initiating execution of, the job.

As mentioned above, the repeatable jobs module 116 identifies a subset of the job schedule instances 306 in the orchestration engine database 110 to execute on the current date that the one-time jobs module 114 did not already identify and process. For example, the repeatable jobs module 116 may identify the subset of the job schedule instances 306 in the orchestration engine database 110 to execute by querying the job schedule instances 306 in the orchestration engine database 110 at a regular interval in order to find the job schedule instances 306 having a frequency greater than one-time and having a ScheduledDate matching the current date. Alternatively or in addition, the repeatable jobs module 116 may identify the subset of the job schedule instances 306 in the orchestration engine database 110 to execute by querying the job schedule instances 306 and the metadata 302 in the orchestration engine database 110 at a regular interval in order to find the job schedule instances 306 occurring on the current date that have not already been indicated as being initiated.

The one-time jobs module 114, the repeatable jobs module 116, and/or any other module that processes any of the job schedule instances 306 may update and/or read a status of the job schedule instances 306. Consequently, the repeatable jobs module 116—or any other module—may determine if any of the job schedule instances 306 has been processed already by reading the status of the job schedule instance 306.

The regular intervals at which the repeatable jobs module 116 and the one-time jobs module 114 may execute may be different from each other. For example, the repeatable jobs module 116 may execute after the one-time jobs module 114. Alternatively, or in addition, the repeatable jobs module 116 may execute multiple times a day, and the one-time jobs module 114 may execute once a day. In addition to the regularly intervals being multiple times day, the regular intervals may be within one or more time-periods each day in some examples. In some examples, the regular intervals may be changed to meet business requirements. For example, if there are no hourly job types, then the regular interval may be daily instead of hourly. However, if an hourly job is later added, then the regular interval may be changed to run hourly.

As indicated above, the repeatable jobs module 116 identifies the subset of the job schedule instances 306 in the orchestration engine database 110 to execute. The repeatable jobs module 116 may find the job schedule fields 204 and corresponding client identifier(s) 308 for the identified subset of the job schedule instances 306. The repeatable jobs module 116 may accomplish this by, for example, selecting the job schedule field 204 and corresponding client identifier 308 when fetching the subset of the job schedule instances 306 in the orchestration engine database 110.

In some examples, after obtaining the job schedule fields 204 and their corresponding client identifier(s) 308, the repeatable jobs module 116 may identify the set of unique field names included in the job schedule fields 204. From that, the repeatable jobs module 116 may, for each client identifier 308, further limit the job schedule instances 306 found to only those clients having a value in the corresponding application database 130 in the field name matching the current date. The repeatable jobs module 116 may accomplish this by searching the metadata 302 in the orchestration engine database 110 to see if any entry has a value in the field name matching the current date for the client. If there is no value in the field name matching the current date for the client, there may be no need to execute any jobs scheduled based on the field name. As in the example explained above, if the field name is birthdate of the employee table, and no employee for the client has a birthdate matching the current date, there may be no need to execute the birthday email job for the client on the current date.

The repeatable jobs module 116 may then send the client-specific jobs message 152 to the client-specific jobs message queue 154, where the client-specific jobs message 152 identifies the type of job or jobs that the job schedule instances 306 indicate are scheduled to execute for the client. The type of job or jobs may be indicated, for example, by the job schedule fields 204 corresponding to the job schedule instances 306 identified by the repeatable jobs module 116 for the client.

The repeatable jobs execution module 122 may read the client-specific jobs message 152 from the client-specific jobs message queue 154. The repeatable jobs execution module 122 may initiate execution of each of the job types identified in the client-specific jobs message 152. For example, the repeatable jobs execution module 122 may send an event over an event bus 156 for each of the job types. An event handler 158 may execute the type of job identified by the corresponding event that the event handler 158 receives. The event handler 158 may access information stored in the orchestration engine 100 and/or the application database 130 in the process of executing, or initiating execution of, the job.

In some examples, the repeatable jobs execution module 122 and the one-time jobs execution module 120 may share the same logic and, therefore, may be implemented as a single module. FIG. 1 illustrates two instances of the client-specific jobs message queue 154. However, in some examples, there may be only one instance of the client-specific jobs message queue 154.

In some examples, the jobs module 112 (such as the repeatable jobs execution module 122 and/or the one-time jobs execution module 120) may be configured to determine and initiate jobs that are unassociated with any of the job schedule instances 306. For example, the one-time jobs module 114 and/or the repeatable jobs module 116 may, at the regular interval, identify, for each client, a set of job types from the job schedule field 204 that may potentially need to execute. Alternatively, or in addition, one or more jobs in the set of job types may be hard-coded. The jobs module 112 may find the respective field name for each job type in the set of job types. The jobs module 112 may search the metadata 302 in the orchestration engine database 110 to see if any entry has a value in the respective field name matching the current date for the client. If there is no value in the respective field name matching the current date for the client, there may be no need to execute any jobs scheduled based on the field name. For example, if the field name is the birthdate field of the employee table, and no employee for the client has a birthdate matching the current date, there may be no need to execute the birthday email job for the client on the current date. However, if there is a value in the respective field name matching the current date for the client, then the jobs module 112 may initiate a job to handle the birthday emails for determined entities in the client's application database 130 in a manner described above.

Some of the modules above are described as sending content in messages to message queues. In some examples, the content may be divided into chunks of a configurable size, and each of the chuncks may be sent in a separate corresponding message.

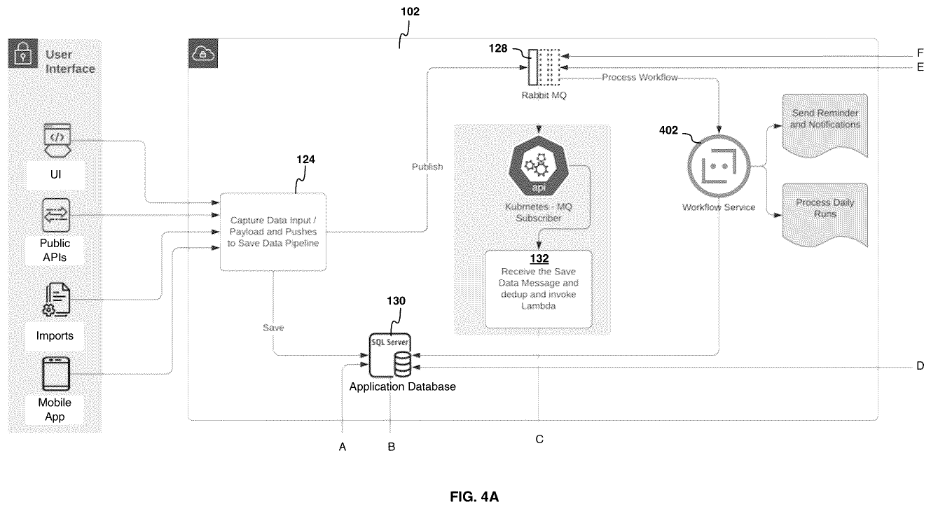

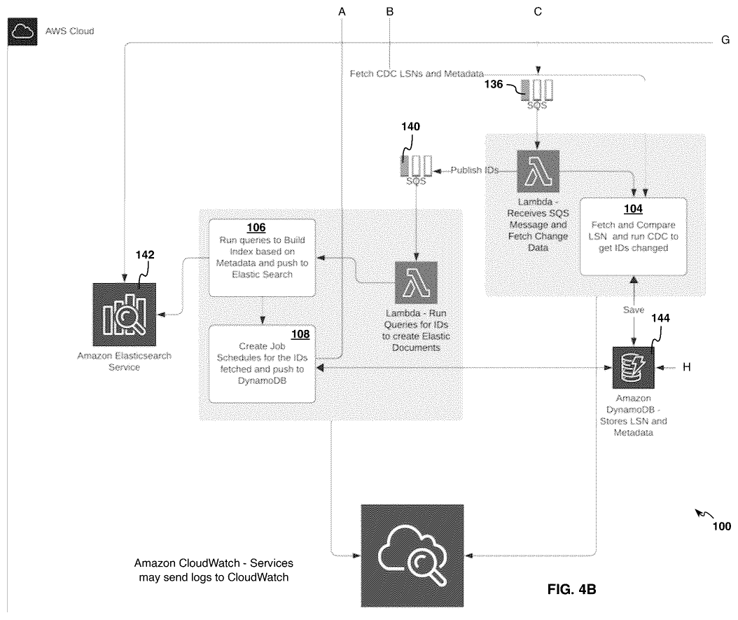

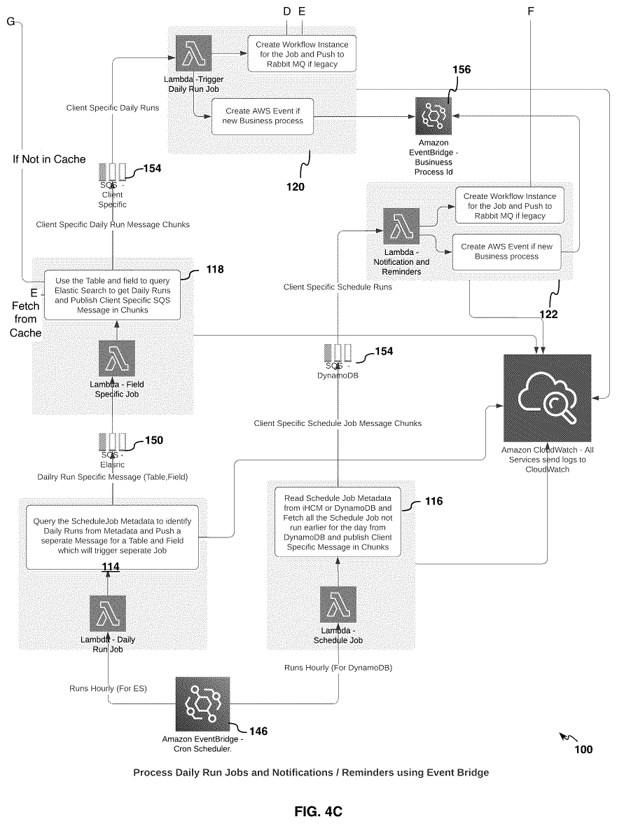

FIG. 4 illustrates an example of the orchestration engine 100 implemented in Amazon's cloud technologies. FIG. 4A shows one instance of the single-tenant application 102 in communication with the orchestration engine 100. FIG. 4B shows a portion of the orchestration engine 100 configured to create and/or update any scheduled jobs based on modifications to data in the application database 130 of the single-tenant application 102. FIG. 4C shows a portion of the orchestration engine 100 configured to identify and initiate job execution.

The single-tenant application 102 in the example shown in FIG. 4A includes a legacy workflow service 402. The legacy workflow service 402 manages various scheduled jobs. As describe further below, the orchestration engine 100 in this example integrates with the legacy workflow service 402. The legacy workflow service 402 receives messages from a queue implemented in a Rabbit MQ messaging broker. The data write message queue 128 is also implemented in the Rabbit MQ messaging broker. The field filter module 132 is implemented in a container on a Kubernetes platform.

The orchestration engine 100 is implemented in the AWS cloud. The queues, such as the written fields message queue 136, the modified rows message queue 140, the schedule job fields message queue 150, and the client-specific jobs message queue 154 are implemented in Amazon Simple Queue Service (SQS). The modules, such as modified rows module 104, the jobs module 112, one-time jobs module 114, the repeatable jobs module 116, and so on, are implemented as code that runs as serverless functions on AWS Lambda, a compute service. The analytics engine 142 is Amazon's Elasticsearch service, which is a cloud-based analytics engine. The NoSQL database 144 is Amazon's DynamoDB, a serverless, NoSQL database service. The services and/or modules may send log information to Amazon CloudWatch, a monitoring service offered by AWS. The job scheduler 146 may be implemented with the Amazon EventBridge Scheduler, which is a serverless scheduler that enables a user to create, run, and manage tasks from one central, managed service. The event bus 156 is provided by Amazon EventBridge.

The orchestration engine 100 in this example integrates with the legacy workflow service 402 in the one-time jobs execution module 120 and the repeatable jobs execution module 122. Each of the jobs execution modules 120 and 122 may first check whether the job is to run in the legacy workflow service 402 or the event handler 158. If the latter, then the jobs execution module 120 or 122 may send the event to the event bus 156 as described further above. Alternatively, if the job is to run in the legacy workflow service 402, then the jobs execution module 120 or 122 may send a suitable message to the Rabbit MQ messaging broker, which the legacy workflow service 402 will asynchronously process and execute the scheduled job.

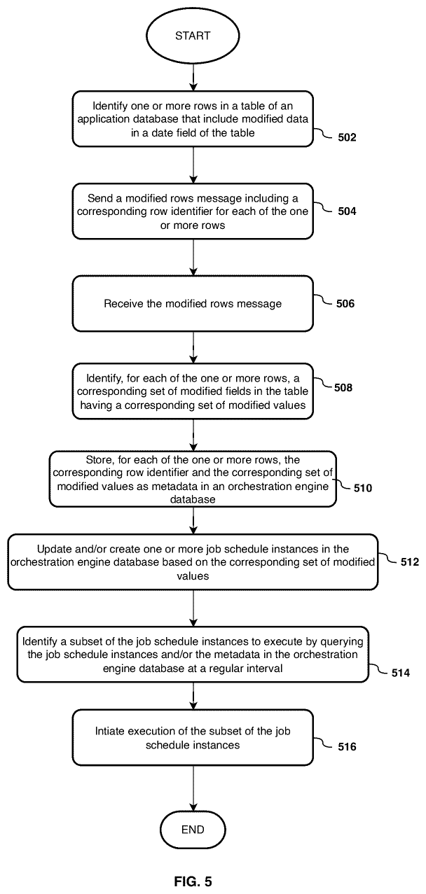

FIG. 5 illustrates an example flow diagram of the logic of the orchestration engine 100. The logic may include additional, different, or fewer operations. The operations may be executed in a different order than illustrated in FIG. 5.

Operations may begin by, for example, with an operation to identify 502 one or more rows in a table of an application database that include modified data in a date field of the table, wherein the application database is for a single-tenant application.

After identification of the one or more rows, operations may proceed to send 504 a modified rows message to a modified rows message queue, the modified rows message including a corresponding row identifier for each of the one or more rows.

A subsequent operation may be to receive 506 the modified rows message from the modified rows message queue.

Operations may include an operation to identify 508, for each of the one or more rows, a corresponding set of modified fields in the table having a corresponding set of modified values.

Operations may proceed to store 510, for each of the one or more rows, the corresponding row identifier and the corresponding set of modified values as metadata in an orchestration engine database.

In addition, operations may include an operation to modify 512 (update, delete, and/or create) one or more of a plurality of job schedule instances in the orchestration engine database based on the corresponding set of modified values in each of the one or more rows.

Subsequently, operations may proceed to identify 514 a subset of the job schedule instances to execute by querying the job schedule instances and/or the metadata in the orchestration engine database at a regular interval.

Operations may end by, for example, with an operation to initiate 516 execution of the subset of the job schedule instances.

The orchestration engine 100 may be implemented with additional, different, or fewer components. In some examples, the orchestration engine 100 may include the event handlers 158. Alternatively, or in addition, the orchestration engine 100 may include the field filter module 132. Alternatively, or in addition, the orchestration engine 100 may include a data warehouse that serves as a central repository for copies of the entities related to the orchestration engine 100 that may be stored in the instances of the application databases 130. This may be more efficient than individually accessing the instances of the application database 130.

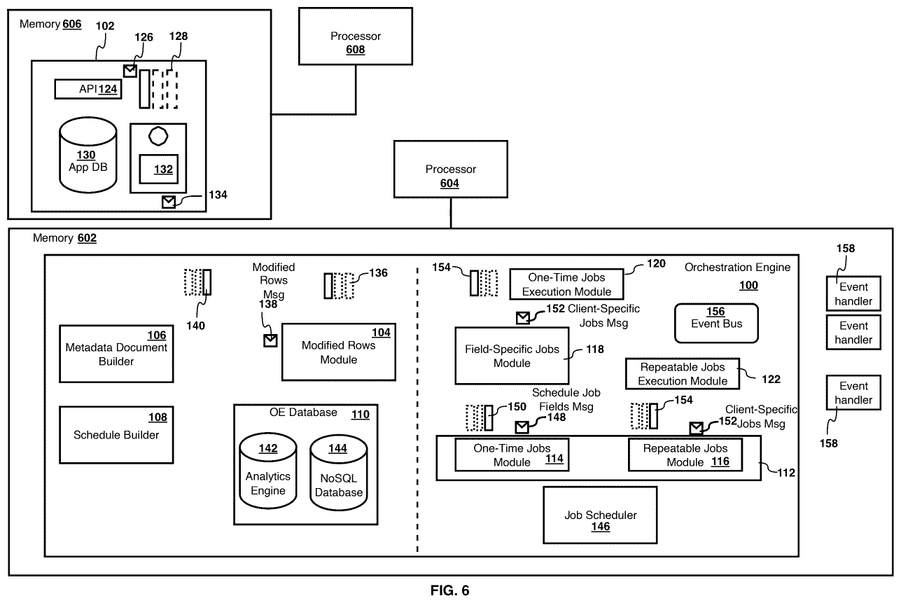

FIG. 6 shows example components of the orchestration engine 100 in a first memory 602. Example components of the single-tenant application 102 are shown in a second memory 606. A first processor 604 is in communication with the first memory 602. A second processor 608 is in communication with the second memory 606.

The first processor 604 and the second processor 608 may be any device that performs logic operations. The first processor 604 and the second processor 608 may also be in communication with additional components, such as a display. The first processor 604 and the second processor 608 may include a controller, a microcontroller, a general processor, a central processing unit, a graphics processing unit, a server device, an application specific integrated circuit (ASIC), a digital signal processor, a field programmable gate array (FPGA), a digital circuit, an analog circuit, a controller, a microcontroller, any other type of processor, or any combination thereof. The first processor 604 and the second processor 608 may include one or more elements operable to execute computer executable instructions or computer code embodied in the memory 602 and 606 or in other memory.

The first memory 602 and the second memory 606 may be any device for storing and retrieving data or any combination thereof. The memory may include non-volatile and/or volatile memory, such as a random-access memory (RAM or DRAM), solid state memory, flash memory, a read-only memory (ROM), an erasable programmable read-only memory (EPROM), and flash memory. Alternatively, or in addition, the memory may include an optical, magnetic (hard-drive), or any other form of data storage device.

Each component may include additional, different, or fewer components. For example, the jobs module 112 may not include the one-time jobs module 114 and the repeatable jobs module 116. As another example, the orchestration engine database 110 may include the analytics engine 142 and/or the NoSQL database 144.

The orchestration engine 100 may be implemented in many different ways. Each module, such as the modified rows module 104, the metadata document builder 106, and the schedule builder 108, may be hardware or a combination of hardware and software. For example, each module may include an application specific integrated circuit (ASIC), a Field Programmable Gate Array (FPGA), a circuit, a digital logic circuit, an analog circuit, a combination of discrete circuits, gates, or any other type of hardware or combination thereof. Alternatively, or in addition, each module may include memory hardware, such as a portion of the first memory 602, for example, that comprises instructions executable with the first processor 604 or other processor to implement one or more of the features of the module. When any of the modules includes the portion of the memory that comprises instructions executable with the processor, the module may or may not include the processor. In some examples, each module may just be the portion of the first memory 602 or other physical memory that comprises instructions executable with the first processor 604 or other processor to implement the features of the corresponding module without the module including any other hardware. Because each module includes at least some hardware even when the included hardware comprises software, each module may be interchangeably referred to as a hardware module, such as the modified rows hardware module 104, the metadata document builder hardware module 106, and the schedule builder hardware module 108.

Some features are shown stored in a computer readable storage medium (for example, as logic implemented as computer executable instructions or as data structures in memory, such as the first memory 602 and the second memory 606). All or part of the orchestration engine and its logic and data structures may be stored on, distributed across, or read from one or more types of computer readable storage media. Examples of the computer readable storage medium may include a hard disk, a floppy disk, a CD-ROM, a flash drive, a cache, volatile memory, non-volatile memory, RAM, flash memory, or any other type of computer readable storage medium or storage media. The computer readable storage medium may include any type of non-transitory computer readable medium, such as flash memory, a CD-ROM, a volatile memory, a non-volatile memory, ROM, RAM, or any other suitable storage device.

The processing capability of the orchestration engine 100 may be distributed among multiple entities, such as among multiple processors and memories, optionally including multiple distributed processing systems. Parameters, databases, and other data structures may be separately stored and managed, may be incorporated into a single memory or database, may be logically and physically organized in many different ways, and may implemented with different types of data structures such as linked lists, hash tables, or implicit storage mechanisms. Logic, such as programs or circuitry, may be combined or split among multiple programs, distributed across several memories and processors.

All of the discussion, regardless of the particular implementation described, is exemplary in nature, rather than limiting. For example, although selected aspects, features, or components of the implementations are depicted as being stored in memories, all or part of the orchestration engine or orchestration engines may be stored on, distributed across, or read from other computer readable storage media, for example, secondary storage devices such as hard disks, flash memory drives, floppy disks, and CD-ROMs. Moreover, the various modules and screen display functionality is but one example of such functionality and any other configurations encompassing similar functionality are possible.

The respective logic, software or instructions for implementing the processes, methods and/or techniques discussed above may be provided on computer readable storage media. The functions, acts or tasks illustrated in the figures or described herein may be executed in response to one or more sets of logic or instructions stored in or on computer readable media. The functions, acts or tasks are independent of the particular type of instructions set, storage media, processor or processing strategy and may be performed by software, hardware, integrated circuits, firmware, micro code and the like, operating alone or in combination. Likewise, processing strategies may include multiprocessing, multitasking, parallel processing and the like. In one example, the instructions are stored on a removable media device for reading by local or remote systems. In other examples, the logic or instructions are stored in a remote location for transfer through a computer network or over telephone lines. In yet other examples, the logic or instructions are stored within a given computer, central processing unit (“CPU”), graphics processing unit (“GPU”), or system.

Furthermore, although specific components are described above, methods, systems, and articles of manufacture described herein may include additional, fewer, or different components. For example, a processor may be implemented as a microprocessor, microcontroller, application specific integrated circuit (ASIC), discrete logic, or a combination of other type of circuits or logic. Similarly, memories may be DRAM, SRAM, Flash or any other type of memory. Flags, data, databases, tables, entities, and other data structures may be separately stored and managed, may be incorporated into a single memory or database, may be distributed, or may be logically and physically organized in many different ways. The components may operate independently or be part of a same program or apparatus. The components may be resident on separate hardware, such as separate removable circuit boards, or share common hardware, such as a same memory and processor for implementing instructions from the memory. Programs may be parts of a single program, separate programs, or distributed across several memories and processors.

A second action may be said to be “in response to” a first action independent of whether the second action results directly or indirectly from the first action. The second action may occur at a substantially later time than the first action and still be in response to the first action. Similarly, the second action may be said to be in response to the first action even if intervening actions take place between the first action and the second action, and even if one or more of the intervening actions directly cause the second action to be performed. For example, a second action may be in response to a first action if the first action includes setting a Boolean variable to true and the second action is initiated if the Boolean variable is true.

FIG. 7 illustrates an example of a table 702 and a change log 704 in the application database 130. The table 702 is an employee table having two rows 706 and each row 706 has a corresponding row identifier 708. As the table 702 in the application database 130 is updated, the application database 130 identifies the change in the change log 704. In the illustrated example, a set of modified fields 710 includes a birthdate and a hire date. A set of modified values 712 includes new values for the set of modified fields 710, which in this example, are the birthdate and hire date fields.

The single-tenant application 102 may be any type of application that where each client (in other words, customer) has its own instance of the application. Examples of the single-tenant application 102 may include a human capital management application, an enterprise resource planning application, a customer relationship management application, a supply chain management application, a human resource management application, and accounting software.

The orchestration engine database 110 and the application database 130 may be any type of database. Such a database may include a memory, like the first memory 602 or the second memory 606, with any electronic collection of information stored therein. The information may be organized so that the information may be accessed, managed, and updated. Examples of the database may include a Structured Query Language (SQL) database, a NoSQL database, a graph database, a Relational Database Management System (RDBMS), an object-oriented database, an extensible markup language (XML) database, a file system, memory structures, or any other organization and storage mechanism. The database may use any type of memory and structure, such as a random-access memory (RAM), a read-only memory (ROM), an erasable programmable read-only memory (EPROM), flash memory, optical memory, magnetic (hard-drive or tape) memory or other memory device.

The analytics engine 142 may be any software that facilitates the processing and analysis of relatively large volumes of raw data. The analytics engine 142 may include a database. The NoSQL database 144 may be any non-relational database that provides handling of diverse datasets using one or more models, such as document, graph, key-value, and/or wide-column stores.

The data API 124 may be any application programming interface through which business processes make modifications to data stored in the application database 130. The data API 124 may be any application programming interface through which access to the application database 130 is centralized.

A message queue is a software component that facilitates asynchronous communication between different parts of a system, acting as a buffer to hold messages until they can be processed by a consumer. The message queues described herein, such as the data write message queue 128, the written fields message queue 136, the modified rows message queue 140, the schedule job fields message queue 150, and client-specific jobs message queue 154, may be any type of message queue. The message queues may be implemented in a general-purpose messaging service or in a proprietary or one-off solution.

Similarly, the messages described herein, such as the data write message 126, the written fields message 134, the modified rows message 138, the schedule job fields message 148, and the client-specific jobs message 152, may be any piece of data that is provided to the message queue to be asynchronous accessed by a consumer of the message queue.

The event bus 156 may be any communication mechanism in software architecture that facilitates event exchange between components or services, enabling loose coupling and/or asynchronous communication through a publish-subscribe pattern. The event handler 158 may be any software component that subscribes to one or more events on the event bus 156.

A scheduled job may be executed one or more times as dictated by a schedule. The schedule may be as simple as date on which the job is to execute or may be more complex. The job may be any task or unit of work that is to be executed by a computing device.

To clarify the use of and to hereby provide notice to the public, the phrases “at least one of <A>, <B>, . . . and <N>” or “at least one of <A>, <B>, . . . or <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed. Unless otherwise indicated or the context suggests otherwise, as used herein, “a” or “an” means “at least one” or “one or more.”

While various examples have been described, it will be apparent to those of ordinary skill in the art that many more examples and implementations are possible. Accordingly, the examples and implementations described herein are descriptive, but not the only possible examples and implementations.

What is claimed is:

1. A multi-tenant orchestration engine for a single-tenant application, the multi-tenant orchestration engine comprising a memory, the memory including:
a modified rows module configured to identify one or more rows in a table of an application database that include modified data in a date field of the table, wherein the application database is for the single-tenant application, wherein the modified rows module is further configured to send a modified rows message to a modified rows message queue, the modified rows message including a corresponding row identifier for each of the one or more rows;
a metadata document builder configured to receive the modified rows message from the modified rows message queue and to identify, for each of the one or more rows, a corresponding set of modified fields in the table having a corresponding set of modified values, wherein the metadata document builder is further configured to store, for each of the one or more rows, the corresponding row identifier and the corresponding set of modified values as metadata in an orchestration engine database;
a schedule builder configured to update and/or create one or more of a plurality of job schedule instances in the orchestration engine database based on the corresponding set of modified values in each of the one or more rows; and
a jobs module configured to identify a subset of the job schedule instances to execute by querying the job schedule instances and/or the metadata in the orchestration engine database at a regular interval, wherein the jobs module is further configured to initiate execution of the subset of the job schedule instances.

2. The multi-tenant orchestration engine of claim 1, wherein the single-tenant application comprises a field filter module configured to write, from the single-tenant application, a written fields message to a written fields message queue, the written fields message identifying the date field that includes the modified data.

3. The multi-tenant orchestration engine of claim 2, wherein the field filter module is further configured to determine a set of search fields for the table, wherein the set of search fields identifies any field in the table which affects scheduling of a job, and the field filter module is further configured to identify the date field in the written fields message only if the date field is included in the set of search fields.

4. The multi-tenant orchestration engine of claim 2, wherein the modified rows module is further configured to receive the written fields message from the written fields message queue, and to identify the one or more rows that include the modified data in the date field of the table based on the date field identified in the written fields message.

5. The multi-tenant orchestration engine of claim 4, wherein the modified rows module is further configured to identify the one or more rows that include the modified data in the date field of the table based on the date field identified in the written fields message and on a change log in the application database.

6. The multi-tenant orchestration engine of claim 1, wherein the metadata document builder is further configured to determine a set of search fields for the table, wherein the set of search fields identifies any field in the table which affects scheduling of a job, and to limit, for each of the one or more rows, the corresponding set of modified fields in the table to the set of search fields for the table.

7. The multi-tenant orchestration engine of claim 1, wherein the jobs module includes a one-time jobs module configured to identify the subset of the job schedule instances to execute by querying the job schedule instances in the orchestration engine database at the regular interval for the job schedule instances having a run start date matching a date on which the orchestration engine database is being queried.

8. The multi-tenant orchestration engine of claim 1, wherein the jobs module includes a repeatable jobs module configured to identify the subset of the job schedule instances to execute by querying the job schedule instances and the metadata in the orchestration engine database.

9. A non-transitory computer readable storage medium comprising computer executable instructions, the computer executable instructions executable by a processor, the computer executable instructions comprising:
instructions executable to identify one or more rows in a table of an application database that include modified data in a date field of the table, wherein the application database is for a single-tenant application;
instructions executable to asynchronously receive, for each of the one or more rows, a corresponding row identifier;
instructions executable to identify, for each of the one or more rows, a corresponding set of modified fields in the table having a corresponding set of modified values;
instructions executable to store, for each of the one or more rows, the corresponding row identifier and the corresponding set of modified values as metadata in an orchestration engine database;
instructions executable to update and/or create one or more of a plurality of job schedule instances in the orchestration engine database based on the corresponding set of modified values in each of the one or more rows;
instructions executable to identify, at a regular interval, a subset of the job schedule instances to execute by querying the job schedule instances and/or the metadata in the orchestration engine database; and
instructions executable to initiate execution of the subset of the job schedule instances.

10. The non-transitory computer readable storage medium of claim 9 comprising instructions executable to asynchronously receive an indication that the date field of the table in the application database includes the modified data.

11. The non-transitory computer readable storage medium of claim 9, wherein the instructions executable to identify the subset of the job schedule instances to execute comprises instructions executable to query the job schedule instances in the orchestration engine database having a run start date matching a current date.

12. The non-transitory computer readable storage medium of claim 11, wherein the instructions executable to identify the subset of the job schedule instances to execute comprises instructions executable to identify a set of field names and their corresponding client identifiers on which the subset of the job schedule instances is scheduled.

13. The non-transitory computer readable storage medium of claim 12, wherein the instructions executable to identify the subset of the job schedule instances to execute comprises instructions executable to limit the subset of the job schedule instances to only clients having a value in the corresponding application database in the corresponding field name in the set of field names, the value matching the current date.

14. The non-transitory computer readable storage medium of claim 13, wherein the instructions executable to limit the subset of the job schedule instances queries the metadata in the orchestration engine to identify only clients having the value in the corresponding application database in the corresponding field name in the set of field names, the value matching the current date.

15. A computer-implemented method comprising:
identifying one or more rows in a table of an application database that include modified data in a date field of the table, wherein the application database is for a single-tenant application;
sending a modified rows message to a modified rows message queue, the modified rows message including a corresponding row identifier for each of the one or more rows;
receiving the modified rows message from the modified rows message queue;
identifying, for each of the one or more rows, a corresponding set of modified fields in the table having a corresponding set of modified values;
storing, for each of the one or more rows, the corresponding row identifier and the corresponding set of modified values as metadata in an orchestration engine database;
updating and/or creating one or more of a plurality of job schedule instances in the orchestration engine database based on the corresponding set of modified values in each of the one or more rows; and
identifying a subset of the job schedule instances to execute by querying the job schedule instances and/or the metadata in the orchestration engine database at a regular interval; and
initiating execution of the subset of the job schedule instances.

16. The computer-implemented method of claim 15 further comprising receiving a written fields message from a written fields message queue, the written fields message identifying the date field that includes the modified data.

17. The computer-implemented method of claim 16 further comprising writing the written fields message to the written fields message queue from the single-tenant application, the written fields message identifying the date field that includes the modified data.

18. The computer-implemented method of claim 15, wherein the one or more rows that include the modified data are identified based on a change log in the application database.

19. The computer-implemented method of claim 15 further comprising determining a set of search fields for the table, wherein the set of search fields identifies any field in the table which affects scheduling of a job, and wherein identifying, for each of the one or more rows, the corresponding set of modified fields in the table includes limiting the corresponding set of modified fields to the set of search fields for the table.

20. The computer-implemented method of claim 15, wherein querying the job schedule instances and the metadata in the orchestration engine database at the regular interval includes querying the job schedule instances in the orchestration engine database having a run start date matching a date on which the orchestration engine database is being queried.
